(19) United States
(12) Patent Application Publication
(10) Pub. No.: US 2016/0032776 A1
(43) Pub. Date: Feb. 4, 2016

(54) REINFORCED COMPOSITE CASE

(71) Applicant: UNITED TECHNOLOGIES CORPORATION, Hartford, CT (US)

(72) Inventors: Sreenivasa R. Voleti, Farmington, CT (US); Thomas J. Robertson, Jr., Glastonbury, CT (US); Darin S. Lussier, Guilford, CT (US)

(21) Appl. No.: 14/776,268

(22) PCT Filed: Mar. 12, 2014
(86) PCT No.: PCT/US2014/024975

§ 371 Date: Sep. 14, 2015

Related U.S. Application Data
(60) Provisional application No. 61/791,664, filed on Mar. 15, 2013.

(51) Int. Cl. F01D 25/24; F01D 25/28; B32B 27/38

(52) U.S. Cl. CPC F01D 25/24; B32B 27/38; F01D 25/28; B32B 2260/021; B32B 2260/046; F05D 2220/32; F05D 2300/603; F05D 2300/614

(57) ABSTRACT

A composite assembly comprises a first composite wall, a second composite wall spaced radially inward from the first outer wall, and a composite reinforcement ring attached to an outer surface of the second composite wall. The composite reinforcement ring includes at least one sidewall having an accessory mounting port formed therethrough.

### BACKGROUND

The described subject relates generally to composite structures, and more specifically to nacelles and fan cases for gas turbine engines.

Composite materials are increasingly used in a variety of applications, including in gas turbine engines. Composite fan containment cases typically include a reinforcement structure retained within a solidified matrix. Cases deflect during certain events, such as blade-off events so the nacelle outer wall and the case are spaced radially apart to accommodate this deflection. Larger gaps result in larger nacelles or smaller bypass ducts, which can increase drag and reduce efficiency of the engine. While deflection of the case can be reduced by making the case thicker, this undesirably increases weight and/or drag. Further, mounting engine accessories such as fluid and air lines directly to the fan case or nacelle surface subjects those accessories to vibration, increases the potential for foreign object damage, and can weaken the integrity of the containment case.

### SUMMARY

A composite assembly comprises a first composite wall, a second composite wall spaced radially inward from the first outer wall, and a composite reinforcement ring attached to an outer surface of the second composite wall. The composite reinforcement ring includes at least one sidewall having an accessory mounting port formed therethrough.

An assembly for a gas turbine engine comprises a nacelle outer wall and a fan case assembly spaced radially inward from the nacelle outer wall. The fan case assembly includes a composite structural case wall, and a composite reinforcement ring attached to an outer surface of the structural case wall. An engine accessory is fastened to a sidewall of the composite reinforcement ring.

A fan case assembly comprises a composite structural case wall and a composite reinforcement ring attached to an outer surface of the structural case wall. The reinforcement ring includes a sidewall extending around a circumferential portion of the structural case wall. An engine accessory attachment port is formed through the sidewall.

### BRIEF DESCRIPTION OF THE DRAWINGS

FIG. 1 illustrates a partial cross-section of an example gas turbine engine, including a fan case assembly spaced radially apart from a nacelle outer wall.

FIG. 2 depicts a detailed sectional view of an example fan case assembly including an externally reinforced fan containment region.

FIG. 3A is a circumferentially facing cross-section of the fan containment region with a reinforcement ring and an engine accessory attachment port disposed on a radial sidewall of the reinforcement ring.

FIG. 3B is a circumferentially facing cross-section of the fan containment region with a reinforcement ring and an engine accessory attachment port disposed on an axial sidewall of the reinforcement ring.

FIG. 4 is a partial axially facing cross-section of a composite case showing a circumferentially segmented reinforcement ring.

### DETAILED DESCRIPTION

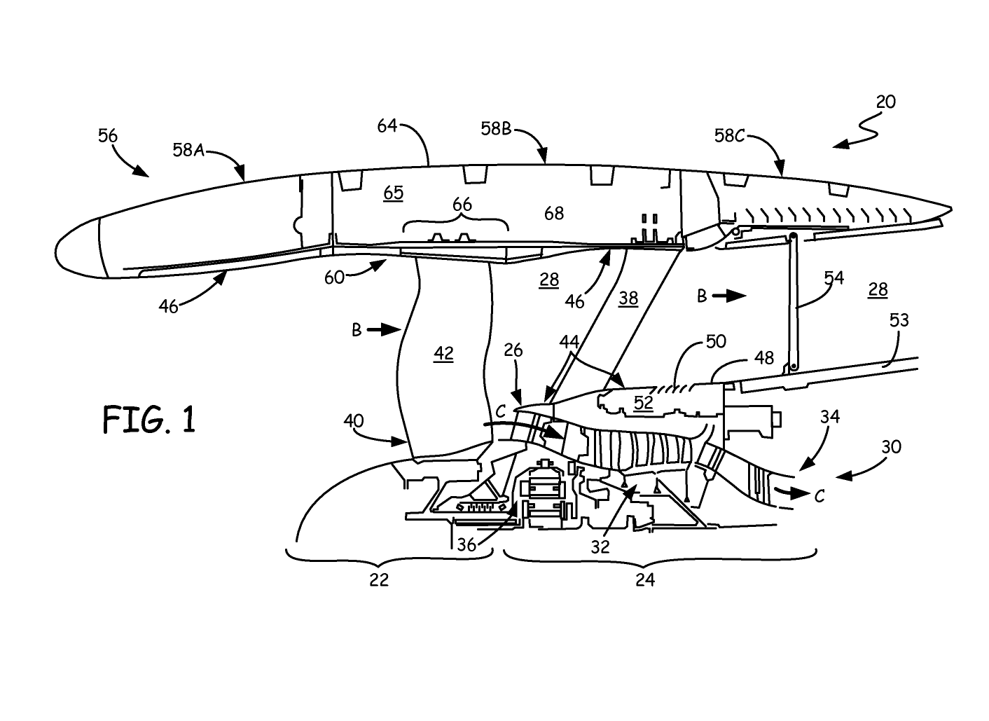

FIG. 1 schematically illustrates a partial cross-section of example gas turbine engine 20 that includes fan section 22 and compressor section 24. Engine 20 can also include a combustor section and one or more turbine sections, both omitted for clarity. FIG. 1 also shows flow splitter 26, bypass duct 28, engine power core 30, low pressure compressor 32, high pressure compressor 34, geared architecture 36, fan exit guide vanes (“FEGVs”) 38, fan 40, fan blades 42, inner duct wall 44, outer duct wall 46, inner fixed structure 48, particle ejection ports 50, cavity 52, thrust reverser panel 53, thrust reverser arm 54, nacelle 56, nacelle segments 58A, 58B, 58C, fan case assembly 60, outer nacelle wall 64, nacelle gap 65, fan containment region 66, and external reinforcement structure 68.

In operation, inlet air can be separated into bypass flow path B and core flow path C at flow splitter 26. Fan section 22 pulls in airflow A and drives air along bypass flow path B (e.g., through bypass duct 28), while compressor section 24 draws air in along core flow path C (e.g., through engine power core 30). In core flow path C, air is compressed by low pressure compressor 32, then is further compressed by high pressure compressor 34, and communicated to a combustor (not shown) where it is mixed with fuel and ignited to generate a high pressure exhaust gas stream. The exhaust gas stream then drives corresponding turbine stages (not shown) to extract energy which is utilized primarily to drive fan section 22 and compressor section 24.

Although the disclosed non-limiting embodiment of engine 20 depicts a two-spool turbofan gas turbine engine with a single fan rotor, it should be understood that the concepts described herein are not so limited. The teachings may be applied to other types of turbine engines; for example a turbine engine including a three-spool architecture in which three spools concentrically rotate about a common axis and where a low spool enables a low pressure turbine to drive a fan directly, or via a gearbox, an intermediate spool that enables an intermediate pressure turbine to drive an intermediate compressor of the compressor section, and a high spool that enables a high pressure turbine to drive a high pressure compressor of the compressor section. Among other systems or features, alternative engines might also include an augmenter section (not shown) and/or multiple fan rotors in fan section 22.

The disclosed gas turbine engine 20 in one example is a high-bypass geared aircraft engine with geared architecture 36. The example geared architecture 36 can be an epicyclical gear train, such as a planetary gear system, star gear system or other known gear system, with a gear reduction ratio of greater than about 2.3. In one disclosed embodiment, gas turbine engine 20 includes a bypass ratio greater than about ten (10:1) and the fan diameter is significantly larger than an outer diameter of low pressure compressor 32. It should be understood, however, that the above parameters are only exemplary of one embodiment of a gas turbine engine including a geared architecture and that the present disclosure is applicable to other gas turbine engines.

Engine 20 also includes Fan Exit Guide Vanes (“FEGVs”) 38 in bypass duct 28. In certain embodiments FEGVs 38 may have both structural and flow conditioning properties. Example gas turbine engine 20 also includes fan 40 that comprises in one non-limiting embodiment less than about twenty-six fan blades 42. In another non-limiting embodiment, fan 40 includes less than about twenty fan blades 42.

Annular bypass duct 28 can be defined by inner duct wall 44 and outer duct wall 46. Inner duct wall 44 can include, for example, an inner fixed structure 48. In certain embodiments inner duct wall 44 also includes particle ejection ports 50 through which foreign particulates entering core flow path C are subsequently ejected outward from one or more stages of low pressure compressor 30 into cavity 52, then out into bypass flow path B (bypass duct 28). Inner duct wall 44 can also include a thrust reverser comprising reverser panels 53, which are actuated via arm 54 extending through bypass duct 28.

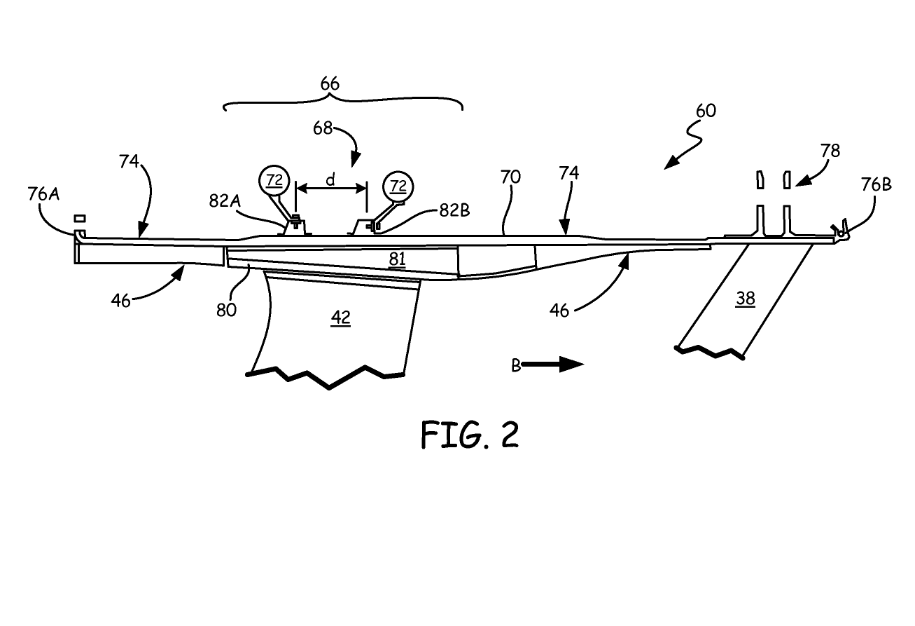

In addition to the portion of outer duct wall 46 disposed in bypass duct 28, outer duct wall 46 can also extend forward of fan 40 and splitter 26 to guide inlet air A into engine 20. Nacelle 56 can include, for example, one or more segments 58A, 58B, 58C. Here, nacelle segment 58B includes fan case assembly 60, spaced radially inward from outer nacelle wall 64 to form nacelle gap 65. Fan case assembly 60 surrounds fan 42 and is adapted to absorb impacts from one or more fan blades in a fan blade-out (FBO) condition, which may occur due to foreign object ingestion or other events. To manage FBO conditions and foreign object ingestion, fan case assembly 60 can include fan containment region 66 such as is shown in FIG. 2. Fan case assembly 60 can also include external reinforcement structure 68 in containment region 66 so as to reduce deflection into outer nacelle wall 64, e.g., to maintain its round shape. This allows for a smaller nacelle gap 65 as compared to a conventional unreinforced composite or hardwall case. This can also improve aerodynamic efficiency of engine 20 by reducing a forward profile of nacelle 56.

FIG. 2 shows a portion of outer duct wall 46 including fan case assembly 60. As illustrated in FIG. 2, assembly 60 also includes fan containment region 66, reinforcement structure 68, fan case outer surface 70, engine accessories 72, structural case wall 74, case wall flanges 76A, 76B, mounting pins 78, abradable surface 80, ballistic web 81, and composite reinforcement rings 82A, 82B.

Fan case assembly 60, defining a portion of spaced apart outer duct wall 46 proximate fan blades 42, includes fan containment region 66 with reinforcement structure 68. External reinforcement structure 68 extends circumferentially around fan case outer surface 70 and reduces radial deflection of containment region 66 into nacelle gap 65 (shown in FIG. 1) during an FBO or other event. As seen in more detail below, engine accessories 72 can be fastened to one or more mounting ports formed into a sidewall of reinforcement structure 68.

Fan case assembly 60 can include a generally tubular (e.g. cylindrical or frustoconical) structural case wall 74 with respective forward and aft mounting flanges 76A, 76B for securing fan case assembly 60 to axially adjacent parts of nacelle 56 and/or outer duct wall 46 (shown in FIG. 1). Flanges 76A, 76B can be formed integrally with, or separately attached to structural case wall 74. One or more mounting pins 78 can support fan exit guide vanes (FEGVs) 38 from an aft side of structural case wall 74.

Fan case assembly 60 can also include abradable surface 80 and/or ballistic web 81 on an inner side of composite structural case wall 74 in fan containment region 66. In use, fan blades 42 can wear a groove into abradable surface (e.g., epoxy-filled honeycomb) 80 to reduce leakage of bypass airflow over the fan blade tips. In an FBO event, portions of liberated fan blades 42 or other foreign objects are thrown radially outward, striking abradable surface 80 and ballistic web 81 to slow the outward momentum of blade fragments and other foreign objects before they can reach composite structural case wall 74. Abradable surface 80, ballistic web 81, and/or composite structural case wall 74 also can be adapted to cause objects to further break apart and retain the fragments before they penetrate fan case assembly 60, and nacelle outer wall 64 (shown in FIG. 1).

External reinforcement structure 68 can include one or more axially spaced apart reinforcement rings 82A, 82B fixed to outer surface 70 of fan case assembly 60. External reinforcement structure 68 can reduce the deflection envelope upon FBO impact in fan containment region 66, allowing for a smaller nacelle gap 65 (shown in FIG. 1) as compared to a conventional unreinforced composite or hardwall case. If the case deflection can be reduced, nacelle 56 (shown in FIG. 1) can be made smaller to improve aerodynamic efficiency and to reduce its forward profile. Alternatively, a smaller nacelle gap 65 can allow for a larger fan diameter. In either case, engine performance can be improved.

In the example of FIG. 2, composite structural case wall 74 and one or more of the composite reinforcement rings 82A, 82B can comprise a reinforcement structure retained within a solidified matrix. Non-limiting examples of suitable reinforcement structures include unidirectional tape, woven (2D and 3D) fabrics, and braided fiber tows. Non-limiting examples of suitable fabric compositions include carbon, silicon carbide, fiberglass, aramid (e.g., Kevlar® or Nomex®), and polyethylene. Non-limiting examples of suitable resins for a matrix include thermoset resins such as epoxy, bismaleimide, and polyimide, or any other suitable material with appropriate mechanical characteristics. The fibers may be coated to improve adherence with the matrix, or they may remain uncoated.

For certain applications, reinforcement plies of both composite structural case wall 74 and rings 82A, 82B can be arranged with the lengths of underlying fibers or fiber weaves arranged generally along a case circumferential direction. Circumferential arrangement of reinforcement fibers can increase hoop strength of composite structural case wall 74, allowing fan case assembly 60 to better absorb one or more lost fan blades or other debris with a minimum of case deflection and load bearing impairment in fan containment region 66.

In certain embodiments, composite structural case wall 74 and one or more composite reinforcement ring(s) 82A, 82B comprise a single co-molded composite article. In these embodiments, application and/or curing of the matrix compound can occur simultaneously for both structural case wall 74 and reinforcement ring(s) 82A, 82B. For example, fibers for the one or more reinforcement rings 82A, 82B are wrapped around a preform of composite structural case wall 74 prior to application of the matrix precursor compound.

In addition to reducing the deflection of structural case wall 74, an axial distance d between any two spaced apart ones of composite reinforcement rings 82A, 82B can be substantially different from first- and second-order coincidence wavelengths of composite structural case wall 74. Judicious axial spacing of composite reinforcement rings 82A, 82B can alter the modal frequency of composite structural case wall 74 from its natural resonant frequency. This prevents coincidence and resonance at certain operational modes of fan 42 that could otherwise cause damage to fan case assembly 60.

Engine accessory attachments 72 can also be fastened to one or more mounting ports formed into a sidewall of one or more composite reinforcement rings 82A, 82B. In doing so, external hardware such as tubes, wires, and other accessories can be attached to fan case assembly without compromising the integrity of structural case wall 74.

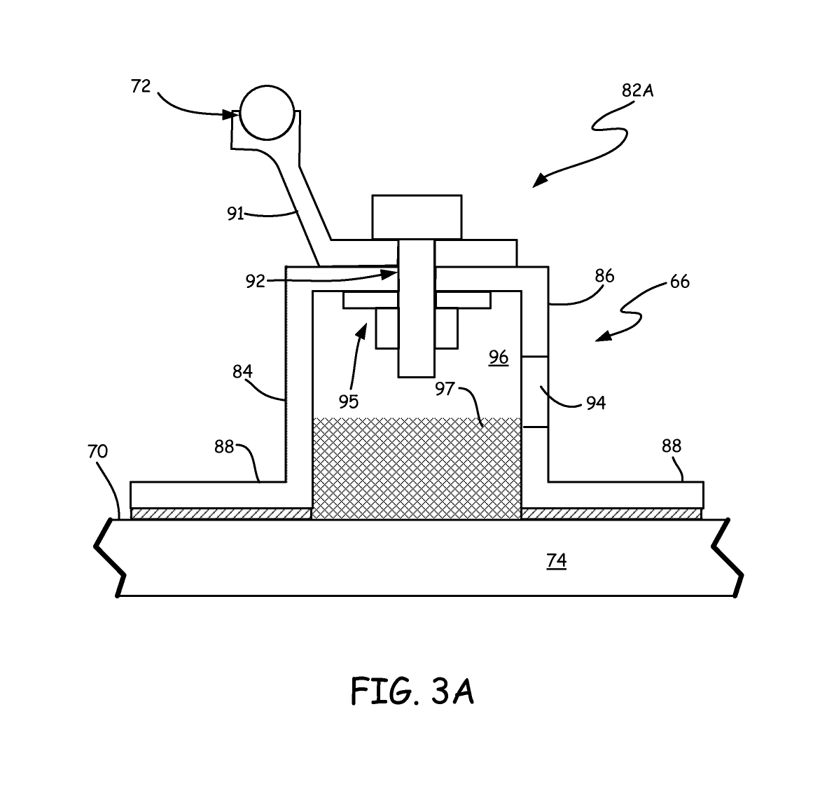

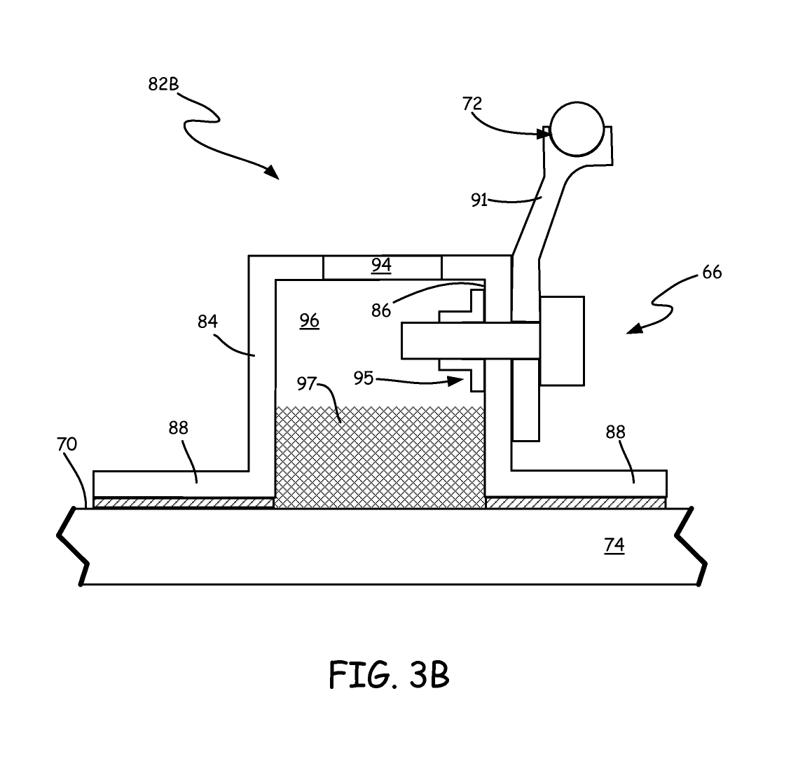

FIGS. 3A and 3B are circumferentially facing cross-sections of fan containment region 66. FIG. 3A shows forward composite reinforcement ring 82A, and FIG. 3B shows aft composite reinforcement ring 82B. FIGS. 3A and 3B also show forward axial sidewall 84, aft axial sidewall 86, sidewall ring flanges 88, radial sidewall 90, accessory mounting bracket 91, engine accessory attachment port 92, mounting access port 94, fastener 95, ring hollow portion 96, and potting compound 97.

In one example, composite reinforcement rings 82A, 82B each include forward axial sidewall 84 and aft axial sidewall 86 each secured to composite fan case outer surface 70. Forward and aft axial sidewalls 84, 86 are shown with flanges 88 which can be adhesively bonded, fastened, or co-molded with fan case outer surface 70. Radial sidewall 90 can also be spaced apart from fan case outer surface 70, connecting forward and aft axial sidewalls 84, 86. Radial sidewall 90 is shown as being perpendicular to forward sidewall 84 and aft sidewall 86 to form rings 82A, 82B with a “hat” shaped cross-section. Alternatively, at least a portion of radial sidewall 90 is curved and can merge into one or both axial sidewalls 84, 86 to form composite reinforcement rings 82A, 82B with an inverted U-shaped cross-section. And while shown in a hollow configuration, it will be recognized that certain embodiments can include one or more rings which are partially or completely solid with no cavity. The solid portion (or entirety) of the ring can be net-molded into shape, or can be filled in after curing and/or installation of the ring.

In this way, engine accessory 72 can be fastened to engine accessory attachment port 92 via bracket 91. In FIGS. 3A and 3B, accessory 72 is shown as a fluid tube running circumferentially around case outer surface 70. Accessory 72 can additionally or alternatively be a wire conduit. A portion of fastener 95 (e.g., a nut plate) on the interior hollow portion 96 is accessible through mounting access port 94. Elastomeric potting compound 97 can additionally be disposed within some or all of hollow portion 96. This provides additional support to ring 82A. Examples of alternative fastening means include traditional nut/bolt arrangements as well as clinch nuts, plus-nuts, and bonded nut plates.

In FIG. 3A, engine accessory attachment port 92 is formed through aft axial sidewall 86. Mounting access port 94, which can be circumferentially aligned with engine accessory attachment port 92, provides access to interior hollow portion 96 of ring 82A. Hollow portion 96 in this example is defined at least in part by forward axial sidewall 84, aft axial sidewall 86, radial sidewall 90, and fan case outer surface 70.

In FIG. 3B, engine accessory attachment port 92 is formed through radial sidewall 90. Mounting access port 94 is circumferentially aligned with engine accessory attachment port 92, and provides access to interior hollow portion 96 through forward or aft axial sidewalls 84, 86. Regardless of whether engine accessory attachment ports 92 are formed through one or more of forward axial sidewall 84, aft axial sidewall 86, and radial sidewall 90, each engine accessory 72 can be supported apart from structural case wall 74. This reduces the potential for vibration being transmitted from structural case wall 74 to engine accessories 72, and can maintain the structural integrity of structural case wall 74 by reducing the need to form mounting holes in the net-molded composite. This arrangement also frees up valuable space in the engine allowing for tighter packing of engine accessories 72 in and around structural case wall 74.

In combination with high bypass ratios made possible with advanced engine designs (e.g., geared architecture 36 shown in FIG. 1), as well as increased electrification of aircraft power systems (e.g., “more electric aircraft”), there can be a need for more complex routing of accessories such as electric, air, fuel, lubrication, and/or communication lines in and around the engine nacelle. At the same time, the efficiency gains achieved in these and other advanced engine designs reduces the availability of suitable mounting areas for these lines and the accessories they communicate with. It is also important to maintain the integrity of such composite cases by minimizing the size and number of holes formed in the net molded walls. Further, many large engines with high bypass ratios are likely to experience substantially different resonance behavior in the bypass duct and/or fan containment case, including coincidence wavelengths which vary substantially from those in more conventional turbofans. Thus providing a plurality of spaced containment rings, as well as the ability to secure engine accessories to a composite case without sacrificing its integrity, can enhance operation and maintainability of many advanced turbofan engines.

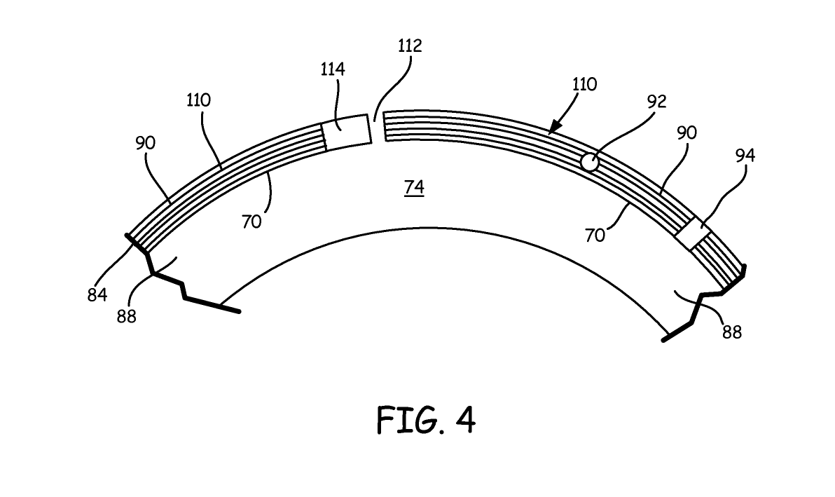

FIG. 4 is an axially facing cross-section of fan containment region 66. FIG. 4 shows a portion of forward composite reinforcement ring 82A disposed around structural case wall 74. FIG. 4 also shows forward axial sidewall 84, radial sidewall 90, engine accessory attachment port 92, mounting access port 94, circumferentially distributed ring segments 110 ring segment junctions 112, and segment cutback portion 114.

As shown in FIG. 4, certain embodiments of composite reinforcement ring 82A can comprise a plurality of circumferentially distributed segments 110. A corresponding plurality of ring segment junctions 112 are disposed between adjacent ones of ring segments 110. In this example, engine accessory attachment ports 92 and/or access ports 94 can be either net molded or secondarily machined through each ring segment 110. In FIG. 4, at least one of the engine accessory attachment ports 92 and/or access ports 94 comprises a cutback portion 114 of a ring sidewall proximate one of the plurality of segment junctions 112.

In certain embodiments, cutback region 114 is formed after curing by machining away a portion of the respective sidewall proximate ring segment junction 112. Alternatively, when forming each ring segment 110, cutback region 114 can be net molded with fiber lengths of a corresponding segment sidewall made shorter than the preforms of the other segment sidewalls. This results in an equivalent cutback region 114 proximate ring segment junction 112, without the need to machine attachment ports 92 and/or access ports 94, which could weaken the integrity of one or more ring sidewall(s). In this way, the integrity of composite reinforcement ring 82A is not compromised by drilling or other secondary post-curing processes.

### Discussion of Possible Embodiments

The following are non-exclusive descriptions of possible embodiments of the present invention:

A composite assembly comprises a first composite wall, a second composite wall spaced radially inward from the first outer wall, and a composite reinforcement ring attached to an outer surface of the second composite wall. The composite reinforcement ring includes at least one sidewall having an accessory mounting port formed therethrough.

The composite assembly of the preceding paragraph can optionally include, additionally and/or alternatively, any one or more of the following features, configurations and/or additional components:

A further embodiment of the foregoing composite assembly, wherein the second composite wall and the reinforcement ring comprise a single co-molded composite article.

A further embodiment of any of the foregoing composite assemblies, wherein the second composite wall and the composite reinforcement ring each comprise a plurality of reinforcement fibers selected from one or more of: carbon fibers, fiberglass fibers, and aramid fibers.

A further embodiment of any of the foregoing composite assemblies, wherein the second composite wall and the composite reinforcement ring each comprise a plurality of reinforcement fibers arranged into a plurality of circumferentially oriented fiber plies.

A further embodiment of any of the foregoing composite assemblies, wherein the composite reinforcement ring comprises: a forward sidewall secured to the outer surface of the second composite wall; an aft sidewall secured to the outer surface of the second composite wall; and a radial sidewall spaced apart from the outer surface of the second composite wall, the radial sidewall connecting the forward sidewall and the aft sidewall.

A further embodiment of any of the foregoing composite assemblies, further comprising: an accessory for a gas turbine engine; wherein the accessory is fastened to the engine accessory attachment port formed through at least one of: the forward sidewall, the aft sidewall, and the radial sidewall.

A further embodiment of any of the foregoing composite assemblies, further comprising: an elastomeric potting compound disposed within a hollow portion of the composite reinforcement ring, the hollow portion defined at least in part by the forward sidewall, the aft sidewall, the radial sidewall, and the fan case outer surface.

A further embodiment of any of the foregoing composite assemblies, wherein the composite reinforcement ring comprises: a plurality of circumferentially distributed ring segments; and a corresponding plurality of segment junctions between adjacent ones of the plurality of ring segments.

A further embodiment of any of the foregoing composite assemblies, further comprising: a mounting access port circumferentially aligned with the engine accessory attachment port; wherein at least one of the engine accessory attachment port and the mounting access port comprises a cutback portion of the sidewall disposed proximate one of the plurality of segment junctions.

A further embodiment of any of the foregoing composite assemblies, wherein the reinforced composite case assembly comprises: a plurality of axially spaced apart composite reinforcement rings fixed to the outer surface of the composite structural case wall, an axial spacing distance between spaced apart ones of the plurality of rings being substantially different from a first-order coincidence wavelength and a second-order coincidence wavelength of the structural case wall.

An assembly for a gas turbine engine comprises a nacelle outer wall and a fan case assembly spaced radially inward from the nacelle outer wall. The fan case assembly includes a composite structural case wall, and a composite reinforcement ring attached to an outer surface of the structural case wall. An engine accessory is fastened to a sidewall of the composite reinforcement ring.

The assembly of the preceding paragraph can optionally include, additionally and/or alternatively, any one or more of the following features, configurations and/or additional components:

A further embodiment of the foregoing assembly, wherein the structural case wall and the reinforcement ring comprise a single co-molded composite article.

A further embodiment of any of the foregoing assemblies, wherein the composite structural case wall and the composite reinforcement ring each comprise a plurality of reinforcement fibers selected from one or more of: carbon fibers, fiberglass fibers, and aramid fibers.

A further embodiment of any of the foregoing assemblies, wherein the composite structural case wall and the composite reinforcement ring each comprise a plurality of reinforcement fibers arranged into a plurality of circumferentially oriented fiber plies.

A further embodiment of any of the foregoing assemblies, wherein the composite reinforcement ring comprises: a forward sidewall secured to the fan case outer surface; an aft sidewall secured to the fan case outer surface; and a radial sidewall spaced apart from the composite fan case outer surface and connecting the forward sidewall and the aft sidewall; wherein the engine accessory is fastened to an engine accessory attachment port formed through at least one of: the forward sidewall, the aft sidewall, and the radial sidewall.

A further embodiment of any of the foregoing assemblies, further comprising: an elastomeric potting compound disposed within a hollow portion of the composite reinforcement ring, the hollow portion defined at least in part by the forward sidewall, the aft sidewall, the radial sidewall, and the fan case outer surface.

A further embodiment of any of the foregoing assemblies, further comprising: a mounting access port circumferentially aligned with the engine accessory attachment port.

A further embodiment of any of the foregoing assemblies, wherein the composite reinforcement ring comprises: a plurality of circumferentially distributed ring segments; and a corresponding plurality of segment junctions between adjacent ones of the plurality of ring segments.

A further embodiment of any of the foregoing assemblies, wherein the engine accessory attachment port comprises a cutback portion of the sidewall disposed proximate one of the plurality of segment junctions.

A further embodiment of any of the foregoing assemblies, wherein the reinforced composite case assembly comprises: a plurality of axially spaced apart composite reinforcement rings fixed to the outer surface of the composite structural case wall, an axial spacing distance between spaced apart ones of the plurality of rings being substantially different from a first-order coincidence wavelength and a second-order coincidence wavelength of the structural case wall.

A fan case assembly comprises a composite structural case wall and a composite reinforcement ring attached to an outer surface of the structural case wall. The reinforcement ring includes a sidewall extending around a circumferential portion of the structural case wall. An engine accessory attachment port is formed through the sidewall.

The fan case assembly of the preceding paragraph can optionally include, additionally and/or alternatively, any one or more of the following features, configurations and/or additional components:

A further embodiment of the foregoing fan case assembly, wherein the composite fan case comprises a plurality of case fibers selected from one or more of: carbon fibers, fiberglass fibers, and aramid fibers.

A further embodiment of any of the foregoing fan case assemblies, wherein the composite reinforcement ring comprises a plurality of reinforcement fibers selected from one or more of: carbon fibers, fiberglass fibers, and aramid fibers.

A further embodiment of any of the foregoing fan case assemblies, wherein the fan case and the reinforcement ring comprise a single co-molded composite article.

A further embodiment of any of the foregoing fan case assemblies, wherein the composite reinforcement ring comprises: a forward sidewall secured to the composite fan case outer surface; an aft sidewall secured to the composite fan case outer surface; and a radial sidewall spaced apart from the composite fan case outer surface and connecting the forward sidewall and the aft sidewall.

A further embodiment of any of the foregoing fan case assemblies, wherein the engine accessory attachment port is formed through a first one of: the forward sidewall, the aft sidewall, and the radial sidewall.

A further embodiment of any of the foregoing fan case assemblies, further comprising: a mounting access port formed through a second one of: the forward sidewall, the aft sidewall, and the radial sidewall, wherein the mounting access port is circumferentially aligned with the engine accessory attachment port.

A further embodiment of any of the foregoing fan case assemblies, wherein the first sidewall comprises a plurality of circumferentially distributed ring segments, and a corresponding plurality of ring segment junctions between adjacent ones of the plurality of ring segments.

A further embodiment of any of the foregoing fan case assemblies, wherein the engine accessory attachment port comprises a cutback portion of the first sidewall proximate one of the plurality of segment junctions.

A further embodiment of any of the foregoing fan case assemblies, further comprising an elastomeric potting compound disposed within a hollow portion of the composite reinforcement ring, the hollow portion defined at least in part by the forward sidewall, the aft sidewall, the radial sidewall, and the composite fan case outer surface.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A composite assembly comprising:
a first composite wall;
a second composite wall spaced radially inward from the first outer wall; and
a composite reinforcement ring attached to an outer surface of the second composite wall, the composite reinforcement ring including at least one sidewall having an accessory mounting port formed therethrough.

2. The composite assembly of claim 1, wherein the second composite wall and the reinforcement ring comprise a single co-molded composite article.

3. The composite assembly of claim 1, wherein the second composite wall and the composite reinforcement ring each comprise a plurality of reinforcement fibers selected from one or more of: carbon fibers, fiberglass fibers, and aramid fibers.

4. The composite assembly of claim 1, wherein the second composite wall and the composite reinforcement ring each comprise a plurality of reinforcement fibers arranged into a plurality of circumferentially oriented fiber plies.

5. The composite assembly of claim 1, wherein the composite reinforcement ring comprises:
a forward sidewall secured to the outer surface of the second composite wall;
an aft sidewall secured to the outer surface of the second composite wall; and
a radial sidewall spaced apart from the outer surface of the second composite wall, the radial sidewall connecting the forward sidewall and the aft sidewall.

6. The composite assembly of claim 5, further comprising:
an accessory for a gas turbine engine;
wherein the accessory is fastened to the engine accessory attachment port formed through at least one of: the forward sidewall, the aft sidewall, and the radial sidewall.

7. The composite assembly of claim 5, further comprising:
an elastomeric potting compound disposed within a hollow portion of the composite reinforcement ring, the hollow portion defined at least in part by the forward sidewall, the aft sidewall, the radial sidewall, and the fan case outer surface.

8. The composite assembly of claim 5, wherein the composite reinforcement ring comprises:
a plurality of circumferentially distributed ring segments; and
a corresponding plurality of segment junctions between adjacent ones of the plurality of ring segments.

9. The composite assembly of claim 1, further comprising:
a mounting access port circumferentially aligned with the engine accessory attachment port;
wherein at least one of the engine accessory attachment port and the mounting access port comprises a cutback portion of the sidewall disposed proximate one of the plurality of segment junctions.

10. The composite assembly of claim 1, wherein the reinforced composite case assembly comprises:
a plurality of axially spaced apart composite reinforcement rings fixed to the outer surface of the composite structural case wall, an axial spacing distance between spaced apart ones of the plurality of rings being substantially different from a first-order coincidence wavelength and a second-order coincidence wavelength of the structural case wall.

11. An assembly for a gas turbine engine, the assembly comprising:
a nacelle outer wall;
a fan case assembly spaced radially inward from the nacelle outer wall, the fan case assembly including a composite structural case wall, and a composite reinforcement ring attached to an outer surface of the structural case wall; and
an engine accessory fastened to a sidewall of the composite reinforcement ring.

12. The assembly of claim 11, wherein the structural case wall and the reinforcement ring comprise a single co-molded composite article.

13. The assembly of claim 11, wherein the composite structural case wall and the composite reinforcement ring each comprise a plurality of reinforcement fibers selected from one or more of: carbon fibers, fiberglass fibers, and aramid fibers.

14. The assembly of claim 11, wherein the composite structural case wall and the composite reinforcement ring each comprise a plurality of reinforcement fibers arranged into a plurality of circumferentially oriented fiber plies.

15. The assembly of claim 11, wherein the composite reinforcement ring comprises:
a forward sidewall secured to the fan case outer surface;
an aft sidewall secured to the fan case outer surface; and
a radial sidewall spaced apart from the composite fan case outer surface and connecting the forward sidewall and the aft sidewall;
wherein the engine accessory is fastened to an engine accessory attachment port formed through at least one of: the forward sidewall, the aft sidewall, and the radial sidewall.

16. The assembly of claim 15, further comprising:
an elastomeric potting compound disposed within a hollow portion of the composite reinforcement ring, the hollow portion defined at least in part by the forward sidewall, the aft sidewall, the radial sidewall, and the fan case outer surface.

17. The assembly of claim 15, further comprising:
a mounting access port circumferentially aligned with the engine accessory attachment port.

18. The assembly of claim 15, wherein the composite reinforcement ring comprises:
a plurality of circumferentially distributed ring segments; and
a corresponding plurality of segment junctions between adjacent ones of the plurality of ring segments.

19. The assembly of claim 18, wherein the engine accessory attachment port comprises a cutback portion of the sidewall disposed proximate one of the plurality of segment junctions.

20. (canceled)

21. A fan case assembly comprising:
a composite structural case wall including an inner surface and an outer surface;
a composite reinforcement ring attached to the outer surface of the structural case wall, the reinforcement ring including a sidewall extending around a circumferential portion of the structural case wall; and
an engine accessory attachment port formed through the sidewall.

22-30. (canceled)
